(19) United States
(12) Patent Application Publication
(10) Pub. No.: US 2009/0165534 A1
(43) Pub. Date: Jul. 2, 2009

(54) METHOD AND APPARATUS FOR TESTING LEAKAGE OF PIPE PASSAGE

(75) Inventors: Gisuke Kohno, Oita (JP); Teruo Hon'Iden, Osaka (JP); Akihiro Morimoto, Osaka (JP); Naofumi Yasumoto, Osaka (JP); Koji Kawada, Osaka (JP); Yutaka Ueji, Osaka (JP); Nobukazu Ikeda, Osaka (JP); Masayuki Hatano, Osaka (JP); Michio Kuramochi, Osaka (JP); Yoshiyuki Kindai, Osaka (JP); Kazuhiro Nagano, Osaka (JP); Toshiaki Wada, Osaka (JP)

Correspondence Address: GRIFFIN & SZIPL, PC, SUITE PH-1, 2300 NINTH STREET, SOUTH, ARLINGTON, VA, 22204, US

(73) Assignees: FUJIKIN INCORPORATION, Osaka-shi (JP); S.E.S. CO., LTD., Ome-city, Tokyo (JP)

(21) Appl. No.: 12/281,564

(22) PCT Filed: Mar. 7, 2007
(86) PCT No.: PCT/JP2007/000161

§ 371 Date: Nov. 25, 2008

(30) Foreign Application Priority Data
Mar. 3, 2006 (JP) 2006-057327

(51) Int. Cl. G01M 3/08

(52) U.S. Cl. 73/49.1

(57) ABSTRACT

A method for testing leakage of a pipe passage employs a flow rate of gas used in testing supplied to the inside of a pipe passage undergoing testing hermetically sealed on one side while detecting flow rate with a flow measuring device and pressure with a pressure detector, and detecting temperature of the gas used, and inputting the detected values of pressure, flow rate and temperature into a computation treatment apparatus, and internal capacity V_{L} of the pipe passage is computed as VL=(supplied flow rate Q×pressure applied time Δt)/(pressure rise value ΔP2), and next, the volume Q_{L} leaked from the pipe passage is computed as Q_{L}=(pressure drop value ΔP2′×internal capacity VL)/(pressure drop time Δt′).

This is a National Phase Application in the United States of International Patent Application No. PCT/JP2007/000161 filed Mar. 2, 2007, which claims priority on Japanese Patent Application No. 2006-057327, filed Mar. 3, 2006. The entire disclosures of the above patent applications are hereby incorporated by reference.

### FIELD OF THE INVENTION

The present invention is to be used, for example, in semiconductor manufacturing facilities, chemical products manufacturing facilities and the like, and relates to a method for testing leakage of various types of gases from supply pipe passages and to a leak testing apparatus to be used for the same.

### BACKGROUND OF THE INVENTION

Many gas supply apparatuses have been employed in semiconductor manufacturing facilities, and the like, and gas supply pipe passages including flow control valves, flow measuring devices, and the like, are under strict control to prevent gas leakage.

With regard to techniques for testing leakage of gas from the pipe passages, various methods have been developed, most of which, in practical use, are methods called “a pressurizing method” because in accordance with the method for detecting leakage, the leakage can be checked throughout the pipe passage under near-actual conditions of usage. Specifically, when the test for which the aforementioned pressurizing method is employed, first, a pipe passage under test conditions is filled with an inactive gas, such as N₂ gas and the like, by applying pressure inside the pipe, and the existence of gas leakage from the pipe passage is checked, after a given lapse of time, using pressure changes. An advantage of the testing method is that an entire pipe passage can be tested simultaneously, and leakage can be detected without fail if there exists leakage of a certain volume or more.

However, there are some disadvantages found with using the pressurizing method. They are that (a) a long testing time is required, (b) it is not easy to spot the precise location of leakage, (c) an exact internal capacity of a pipe passage undergoing testing has to be obtained to determine the degree of leakage from the leakage test results because pressure drop velocity changes largely depending on the internal capacity of the pipe passage undergoing testing, and the like.

In particular, there are a large variety of pipe passages that may undergo testing of this kind. Therefore, it is practically impossible that the internal capacities of pipe passages are obtained with accuracy on a piping chart. So, when actual leakage testing of a pipe passage is performed, the leaked volume (Pa·m³/sec) associated with internal capacity of the pipe passage cannot be employed as a base to determine the degree of leakage from leakage testing of the pipe passage. As a result, it has been common practice to use the pressure drop rate (%) of the entire pipe passage in order to determine the degree of leakage from the leakage test of the pipe passage.

In order to overcome the disadvantages encountered with leakage tests using the pressurizing method, a technique, as described in Japanese Unexamined Patent Application Publication No. 9-28803, has been developed wherein either a discharge gas treatment means or a pipe passage capacity variable means is installed on a measuring device in order to measure the pressure drop quantity of a pipe passage under a hermetically sealed state within a given time, and in order to measure the pressure drop quantity of the pipe passage under a state of continually discharging a fixed volume of a gas from the pipe passage, so that the internal capacity of the pipe passage undergoing testing is obtained using data of both kinds of measurements. In this way, the volume leaked is computed based on both the internal volume of the pipe passage and on the aforementioned pressure drop volume obtained within a fixed time period. Another technique has also been developed, as described in Japanese Unexamined Patent Application Publication No. 2002-286579, wherein computation of the internal capacity of the pipe passage undergoing testing, and detection of the leaked volume of the pipe passage, are conducted by means of 2 kinds of variable capacity add-on containers (i.e., No. 1 and No. 2 capacity add-on containers) installed on a testing device, and pressure changes are measured by a pressure gauge at the time when the aforementioned No. 1 variable capacity add-on container, or the No. 2 variable capacity add-on container, is operated for changes in volume.

The aforementioned techniques make it possible to detect the internal capacity of the pipe passage undergoing testing and to detect the leaked volume from the pipe passage undergoing testing in a fairly accurate manner. Thus, these techniques have excellent effects with respect to determining the degree of the leaked volume of a pipe passage undergoing testing. However, even with these pressurizing method techniques, there still remain many problems to solve. For example, although the leaked volume of a gas can be detected accurately and promptly compared to when leaked volume is estimated by using an amount of pressure drop as is used by conventional “at-a-glance guide to leakage of a gas” techniques, fundamental problems remain unsolved. For example, (a) downsizing of testing devices cannot be achieved because the testing devices need to be equipped with a discharge gas treatment means and a pipe passage capacity variable means (i.e., a variable capacity add-on container), (b) complicated and time-consuming operations for detecting the capacity of the pipe passage and the leaked volume are required, (c) highly accurate detection of the internal capacity of the pipe passage and the leaked volume cannot be achieved because there is no means for taking into account variations caused by temperature changes at the time the test is conducted, and the like.

Patent Document 1: Japanese Unexamined Patent Application Publication No. 9-288031. Patent Document 2: Japanese Unexamined Patent Application Publication No. 2002-286579.

### OBJECT OF THE INVENTION

It is the principal object of the present invention to provide a method for testing leakage that makes it possible that the internal capacity of a pipe passage, and for the leaked volume, to be detected simply and promptly using a very small-sized testing device, and so that an accurate assessment of the degree of leaked volume of the pipe passage is obtained and that is related to the internal capacity of the pipe passage undergoing testing. It is the principal object of the present invention to provide an apparatus for testing the leakage to be used for performing the method, thus solving the problems explained above encountered with methods and apparatuses for testing leakage of a pipe passage. In other words, it is an object of the invention (a) to avoid the need for a testing apparatus that is larger in size and exhibits insufficient handleability, (b) to avoid complicated and time-consuming operations for detecting the internal capacity of the pipe passage and the leaked volume, (c) to overcome the limits of relatively low detecting accuracy due to limits with respect to the detected values of the internal capacity of the pipe passage and the leaked volume because these detected values are largely affected by temperature changes, and the like.

### SUMMARY OF THE INVENTION

The present invention, in accordance with a first embodiment, is fundamentally constituted so that a certain flow rate of a gas used in testing is supplied to the inner side of a pipe passage undergoing testing and that is hermetically closed from opening on one side while detecting a flow rate with a flow measuring device and detecting pressure with a pressure detector, and detecting the temperature of the gas used in testing, and supplied to the aforementioned pipe passage, and the aforementioned detected values of pressure, flow rate and temperature are inputted into a computation treatment apparatus, and an internal capacity V_{L} of the pipe passage undergoing testing is computed as V_{L}=(supplied flow rate Q)×(pressure applied time Δt)/(pressure rise value ΔP₂), using the pressure applied time Δt required for the pressure rise value ΔP₂ of the pipe passage undergoing testing to reach a set value, and the supplied flow rate Q of the gas used in testing in the interim, and, next, computing the volume Q_{L} leaked from the pipe passage undergoing testing as Q_{L}=(pressure drop value ΔP_{2′})×(internal capacity V_{L} of the pipe passage)/(pressure drop time Δt′), using the pressure drop value ΔP_{2′} after a lapse of the given pressure drop time Δt′ subsequent to the application of pressure to the inside of the aforementioned pipe passage undergoing testing to the given set pressure, and the internal capacity V_{L} of the pipe passage is computed as above.

The present invention, in accordance with a second embodiment modifies the first embodiment so that the pressure value corresponding to a pressure detecting signal P₂ is corrected with respect to temperature using a temperature detecting signal T, and the internal capacity V_{L} and leaked volume Q_{L} of the pipe passage undergoing testing are computed using the pressure value corrected according to the value at the predetermined standard temperature.

The present invention, in accordance with a third embodiment modifies the first embodiment or the second embodiment so that the internal pressure of the pipe passage used in the computation of the internal capacity V_{L} of the pipe passage is raised from 0.1 MPa to 0.2 MPa, and the maximum pressurization value is made to be 0.4 Mpa, and the pressure drop time Δt′ is made to be 1 hour for computation of the leaked volume Q_{L}.

The present invention, in accordance with a fourth embodiment modifies the first embodiment or the second embodiment so that a pressure type flow controller is used as the flow measuring device and as the pressure detecting device, and the flow rate detecting signal and pressure detecting signal of the pressure type flow controller are utilized as the aforementioned flow rate detecting signal Q and pressure detecting signal P_{2,} respectively.

The present invention, in accordance with a fifth embodiment, is fundamentally constituted so that a certain flow rate of gas used in testing is supplied to the inner side of the pipe passage undergoing testing and that is hermetically closed from opening on one side while detecting a flow rate with the flow measuring device and the pressure with the pressure detector, and the temperature of the gas used in testing is supplied to the aforementioned pipe passage is detected, and the aforementioned detected values of the pressure, flow rate and temperature are inputted into the computation treatment device, and the internal capacity V_{L} of the pipe passage undergoing testing is computed as V_{L}=(supplied flow rate Q)×(pressure applied time Δt)/(pressure rise value ΔP₂), using the pressure applied time Δt required for the pressure rise value ΔP₂ of the pipe passage undergoing testing to reach the set value and the supplied flow rate Q of gas used in testing in the interim, and next, the gas used in testing is supplied while detecting the flow rate using the aforementioned flow measuring device, and the aforementioned gas used in testing is supplied in a state wherein the pressure P₂ in the pipe passage undergoing testing is maintained at a given value by means of the automatic pressure controller so that the leaked volume Q_{L} from the pipe passage undergoing testing can be obtained using the flow rate Q detected by means of the aforementioned flow measuring device.

The present invention, in accordance with a sixth embodiment further modifies the first embodiment or the fifth embodiment so that a process is included wherein the supply of gas used in testing is temporarily halted during a time when pressure is rising, and pressure changes inside the pipe passage undergoing testing are confirmed.

The present invention, in accordance with a seventh embodiment, is fundamentally constituted so that the computation treatment apparatus is provided with a supply source of gas used in testing so as to supply gas to the pipe passage undergoing testing, the flow measuring device for detecting a given flow rate of gas used in testing flowing into the hermitically closed pipe passage undergoing testing from the supply source, the pressure detecting device for detecting pressure, the temperature detecting device for detecting temperature of the aforementioned pipe passage or of the temperature of the gas used in testing, a computation part for computing the internal capacity of the pipe passage, wherein the flow rate detecting signal Q from the aforementioned flow measuring device, the pressure detecting signal P₂ from the pressure detecting device and the temperature detecting signal T from the pressure detecting device are inputted so that the internal capacity V_{L} of the pipe passage is computed as V_{L}=(supplied flow rate Q)×(pressure applied time Δt)/(pressure rise value ΔP₂), using the pressure applied time At required for the pressure rise value ΔP₂ of the pipe passage undergoing testing to reach a set value and the supplied flow rate Q of the gas used in testing in the interim, and a computation part for computing a leaked volume Q_{L}, which is computed as Q_{L}=(pressure drop value ΔP₂′)×(internal capacity V_{L} of a pipe passage)/(pressure drop time Δt′), using the pressure drop value ΔP₂′ after a lapse of the prescribed pressure drop time Δt′ of the internal pressure of the pipe passage undergoing testing and that is pressurized to the prescribed pressure, and the internal capacity V_{L} of the pipe passage undergoing testing is computed as above.

The present invention, in accordance with a eighth embodiment modifies the seventh embodiment or the second embodiment so that the computation treatment apparatus is provided with a temperature correction part for receiving a pressure detecting signal P₂ and a data storage part.

The present invention, in accordance with a ninth embodiment modifies the seventh embodiment or the eighth embodiment so that a pressure type flow measuring device is utilized as the flow measuring device and as the pressure detector.

### EFFECT OF THE INVENTION

The present invention is constituted so that, first, the internal capacity of a pipe passage undergoing testing is computed using a computation treatment device by using a flow rate detecting signal Q from a flow rate measuring device, a pressure detecting signal P₂ from a pressure detector and a temperature detecting signal T from a temperature detector, and the leaked volume of the pipe passage is computed using the computed internal capacity and the pressure drop value of the pipe passage detected after a lapse of a given time. As a result of the present invention, the structure of the computation treatment device can be substantially simplified compared with conventional leakage testing methods of this type, and the internal capacity and the leaked volume of the pipe passage can be computed using shorter pressure rise times and pressure drop times, and the degree of leakage can be logically determined using shorter testing times and improved test results. Furthermore, in accordance with the present invention, the method and apparatus are constituted so that temperature correction of the pressure detection value is performed using the computation treatment device, thus making it possible to obtain highly accurate testing results because measurement errors caused by temperature changes are reduced. In addition, further simplification of the leakage testing device while achieving testing high accuracy can be achieved by making use of a pressure type flow controller.

### BRIEF DESCRIPTION OF DRAWINGS

FIG. 1 is a schematic diagram with regard to a first embodiment of the method for testing leakage in accordance with the present invention.

FIG. 2 is a schematic block diagram of a computation treatment device that makes up the apparatus for testing leakage in accordance with the present invention.

FIG. 3 is a schematic diagram with regard to a second embodiment of the method for testing leakage in accordance with the present invention.

FIG. 4 is a schematic diagram with regard to a third embodiment of the method for testing leakage in accordance with the present invention.

FIG. 5 is a schematic diagram illustrating an example of the method for testing leakage in accordance with the present invention.

FIG. 6 is a graph showing the relationship (i.e., a pressure rise rate) between the internal pressure of a pipe passage and time at the time of pressure supply (supply pressure 0.3 MPa) of the pipe passage undergoing testing and time at the time pressure is supplied (supply pressure 0.3 MPa) for the pipe passage undergoing testing.

FIG. 7 is a graph showing the relationship (a pressure drop rate) between internal pressure of the pipe passage and time at the time of pressure enclosure (enclosure pressure 0.3 MPa) for the pipe passage undergoing testing.

FIG. 8 is a graph similar to that of FIG. 6, but with respect to the case wherein the supply pressure is made to be 0.5 MPa.

FIG. 9 is a graph similar to that of FIG. 7, but with respect to the case wherein the enclosure pressure is made to be 0.5 MPa.

### REFERENCE CHARACTERS AND NUMERALS

A Apparatus for testing leakage of a pipe passage

N₂ Gas used in testing

P₂ Pressure detecting signal

Q Flow rate detecting signal

T Temperature detecting signal

V_{L} Internal capacity of the pipe passage

Δt Pressure application time

ΔP₂ Pressure rise value

t₁ Starting time of test pressurization

ΔP₂′ Pressure drop value

Δt′ Pressure drop time

S Pressure drop velocity

Q_{L} Leaked volume

Q_{S} Control signal

S_{P} control signal

V₁, V₂ Valves

P₂₀ Value under the condition of the pressure detection value P₂ being at 0° C.

1 Pressure reducing apparatus

2 Pressure detector

3 Flow rate measuring device

4 Pressure detector

5 Temperature detector

6 Pipe passage undergoing testing

7 Computation treatment apparatus

8 Supply source of the gas (N₂) used in testing

9 Computation part for the internal capacity of the pipe passage

10 Computation part for the leaked volume

11 Temperature correction part

12 Data storage part

13 Display part

14 Setting and inputting part

15 Orifice

16 Automatic pressure controller

17 Control valve

18 Pressure detector

19 Leak sample

20 Blind

21 SUS pipe passage (φ0.35 mm)

22 SUS pipe passage (φ0.52 mm)

23 Closing valve

### DISCLOSURE OF THE INVENTION WITH BEST MODE FOR CARRYING OUT THE INVENTION

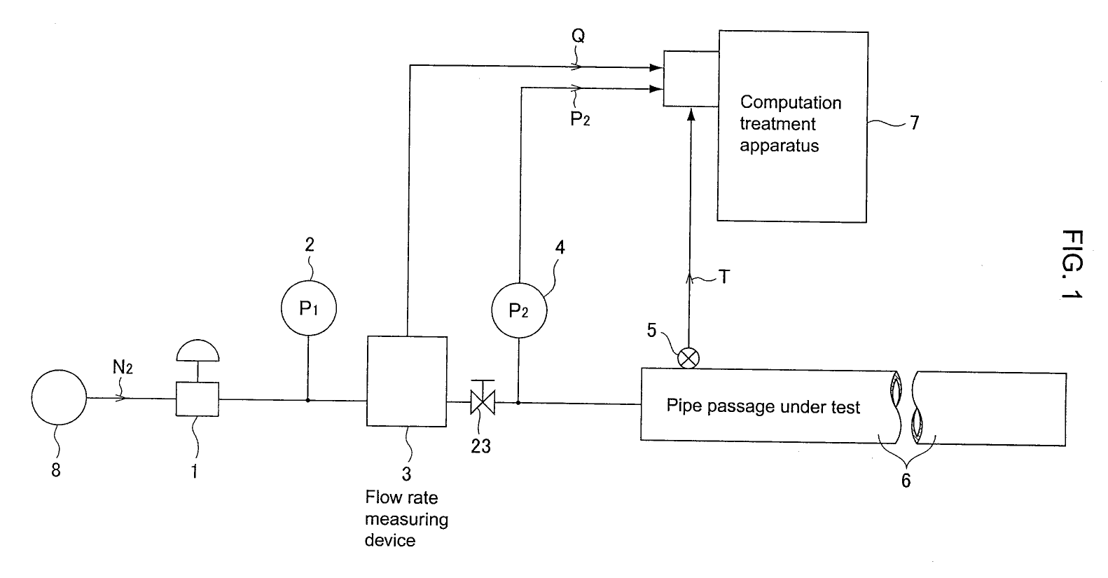

Preferred embodiments in accordance with the present invention are explained hereafter with reference to the drawings. FIG. 1 is a schematic diagram regarding an embodiment of the method of testing leakage, in accordance with the present invention, wherein 1 designates a pressure reducing apparatus, 2 designates a pressure detector, 3 designates a flow rate measuring device, 5 designates a temperature detector, 6 designates a pipe passage undergoing testing, 7 designates a computation treatment apparatus, 8 designates a supply source of a gas (N₂) used in testing, Q designates a flow rate detecting signal, P₂ designates a pressure detecting signal, and T designates a temperature detecting signal.

The aforementioned pressure reducing apparatus 1 and pressure detector 2 can be of any type of construction. In accordance with the present embodiment, a pressure adjusting valve and a semiconductor type pressure sensor are used as the pressure reducing apparatus 1 and a pressure detector 2, respectively. The aforementioned pressure detector 4 can be of any type as long as it is constituted so that the detected value can be outputted outside of the pressure detector 4 as a pressure detecting signal. A semiconductor type pressure transducer has been employed in accordance with the present embodiment. Similarly, the flow rate measuring device 3 can be of any type as long as it is constituted so that the measured value can be outputted outside of the flow rate measuring device 3 as a flow rate detecting signal Q. For example, a thermal type mass flow controller, a pressure type flow controller, and the like, equipped with both a function for adjusting flow rate and a function for measuring flow rate of N₂ gas used in testing, or a thermal type mass flow meter, and the like, equipped only with a function for measuring flow rate of the N₂ gas used in testing, and which has been adjusted to a desired, given flow rate with a regulator, can do the job. In accordance with the present embodiment, an MFC (a thermal type flow controller) has been employed as the flow rate measuring device 3.

The aforementioned temperature detector 5 is for detecting the temperature of the gas (a fluid) in the pipe passage 6 undergoing testing as described later. Normally, the temperature detector 5 is fixed on the outer surface of the pipe passage 6 because the temperature on the outer surface is made to be the same as the gas temperature. With the present embodiment, a thermocouple has been used for the aforementioned temperature detector 5, and the detected value is outputted outside of the temperature detector as a temperature detecting signal T.

Equipment, such as valves, filters, and the like, installed on the pipe passage and equipment, such as a chamber, and the like, installed inside the pipe passage are included in the aforementioned pipe passage 6 undergoing testing. The form and size of the pipe passage undergoing testing are appropriately chosen depending on the situation of the production site. It goes without saying that the aforementioned pipe passage 6 undergoing testing is hermetically sealed.

The aforementioned computation treatment apparatus 7 comprises a setting and inputting part 14, a computation part 9 for computing the internal capacity of a pipe passage, a computation part 10 for computing the leaked volume, a temperature correction part 11, a data storage part 12, a display part 13, and the like, and is made to be transportable.

The aforementioned setting and inputting part 14 is a mechanism for performing various kinds of settings of the detection range and the detection time for the pressure changes corresponding to the flow rate detecting signal Q, the pressure detecting signal P₂ and the temperature detecting signal T (pressure application time Δt and pressure drop time Δt′), and also for establishing the criteria for determining the degree of leakage. The setting and inputting part 14 is also a mechanism for inputting various basic data, and the like, required for computation of the internal quantity V_{L} and of the leaked volume Q_{L} of a pipe passage, into the data storage part 12.

The aforementioned computation part 9 for the internal capacity of a pipe passage is a mechanism for computing the internal capacity of a pipe passage 6 undergoing testing by using the inputted flow rate detecting signal Q, the pressure detecting signal P₂, and the temperature detecting signal T. Using the N₂ flow rate Q, the pressure application time Δt, and temperature-corrected pressure rise value ΔP₂, which are set at given values at the time when the pipe passage 6 undergoing testing is pressurized with an inactive gas (N₂) from a supply source of gas used in testing, the internal capacity V_{L} of the pipe passage 6 undergoing testing is computed as V_{L}=(flow rate Q×pressurized time Δt)/pressure rise value ΔP₂(temperature-corrected) . . . equation (1).

Although the length of the pipe passage 6 undergoing testing, or the type of equipment used therein, makes a difference, normally under the condition wherein the outlet side pressure of the pressure reducing apparatus 1 is adjusted to, and maintained at, a given value (e.g., 0.5 MPa), an inactive gas (N₂) is adjusted to a given flow rate Q by flow rate measuring device 3 so that the supply of the inactive gas is maintained until the detected pressure P₂, obtained using pressure detector 4, exceeds the pressure of 0.1 MPa˜0.2 MPa. Under these conditions, the inside of a pipe passage 6 undergoing testing is continuously pressurized, and the pressure application time Δt required for the testing pressure P₂ to reach 0.1 MPa˜0.2 MPa is computed. The flow rate Q of the inactive gas (N₂) supplied is automatically maintained at a given flow rate using the flow rate measuring device 3. As a result, the flow rate detecting signal Q is maintained at a given set value during the pressure application time Δt even when the pressure detecting value P₂ increases.

The aforementioned flow rate detecting signal Q, pressure detecting signal P₂, and temperature detecting signal T, are continuously inputted into the computation treatment apparatus 7 from the start of the leakage testing time t₁. The computation treatment apparatus stores the aforementioned detecting signals Q, P₂ and T in the data storage part 12 at every given interval after the start of the leakage testing time t₁. And, when the detected value of the pressure detecting signal P₂ reaches the highest set value (i.e., 0.2 MPa), the computed value of the internal capacity V_{L} of the test passage 6 undergoing testing is computed in accordance with the aforementioned equation (1) and the computed value of the internal capacity V_{L} is eventually displayed on the display part 13.

The function of the aforementioned temperature correction part 11 is to correct variations of the pressure detecting signal P₂ caused by temperature. Specifically, the pressure detecting value P₂ (MPa) at room temperature T (° C.) is corrected to a pressure value at 0° C., and pressure P₂₀ (MPa) after temperature correction is computed as P₂₀ (MPa)=[[(P₂+0.101325)×273/(T+273)]—0.101325]. Using the temperature correction part 11, a pressure rise value is computed using the pressure detecting signal P₂₀, for which temperature correction was performed as above, thus making it possible to achieve a highly accurate computation of the internal capacity of the pipe passage 6 undergoing testing.

When the internal capacity of the aforementioned pipe passage 6 undergoing testing is computed, computation is conducted under the assumption that there exists no large leakage even though there is a slight leakage observed from the pipe passage 6 undergoing testing. To ascertain whether or not there exists a large leakage, it is desirable to check the pressure changes inside the pipe passage undergoing testing by halting the supply of the N₂ gas used in testing while the pressure is rising in the pipe passage.

The aforementioned computation part 10 for the leakage volume is used for computing the leaked volume from the pipe passage 6 undergoing testing by using the internal capacity V_{L} of the pipe passage 6 undergoing testing previously computed by the aforementioned computation part 9 for the internal capacity of the pipe passage. Specifically, N₂ gas is supplied inside the pipe passage 6 undergoing testing from the supply source 8 of the gas used in testing by using the pressure reducing apparatus 1 so that the inside of the pipe passage is pressurized to the prescribed pressure (i.e., approximately 0.4 MPa). Then, the detected value of the pressure P₂ inside the pipe passage, and the detected value of the temperature T of the pipe passage, are stored in the data storage part 12 at every given time of detection, and the leaked volume Q_{L} is computed, using the below-stated equation (2), by using the temperature-corrected pressure drop value ΔP₂′ and pressure drop time Δt′.

Leaked volume Q_{L}=(pressure drop value ΔP₂′ (temperature corrected))×(internal capacity V_{L} of the pipe passage)/(pressure drop time Δt′)=(pressure drop velocity S)×(internal capacity V_{L} of the pipe passage) equation (2)

Just as in the case when computing the internal capacity V_{L} of the aforementioned pipe passage 6, the pressure drop value ΔP₂′, and the like, obtained at a specific time during the leakage test are appropriately stored in the data storage part 12. The leaked volume Q_{L}, computed with equation (2), is then displayed on the display part 13, and the pressure drop volume S (i.e., pressure drop velocity S) per unit of time is computed from a predetermined allowable leakage volume using the following equation (3):

=(allowable volume of leakage)/(internal capacity of the pipe passage) equation (3)

In other words, the pressure drop velocity S in equation (3) is the criterion used to determine whether or not the leaked volume Q_{L} from the pipe passage 6 undergoing testing is within the allowable range. The aforementioned allowable leakage volume from the pipe passage undergoing testing is generally determined through a consultation between the test conductor and the user.

The pressure drop velocity S is computed using the leaked volume Q_{L} computed by the aforementioned equation (2). The computed pressure drop velocity S and the predetermined criterion for judgment (i.e., the pressure drop velocity determined based on the allowable volume of leakage) are compared to determine how the pipe passage 6 undergoing testing is to be treated after the test.

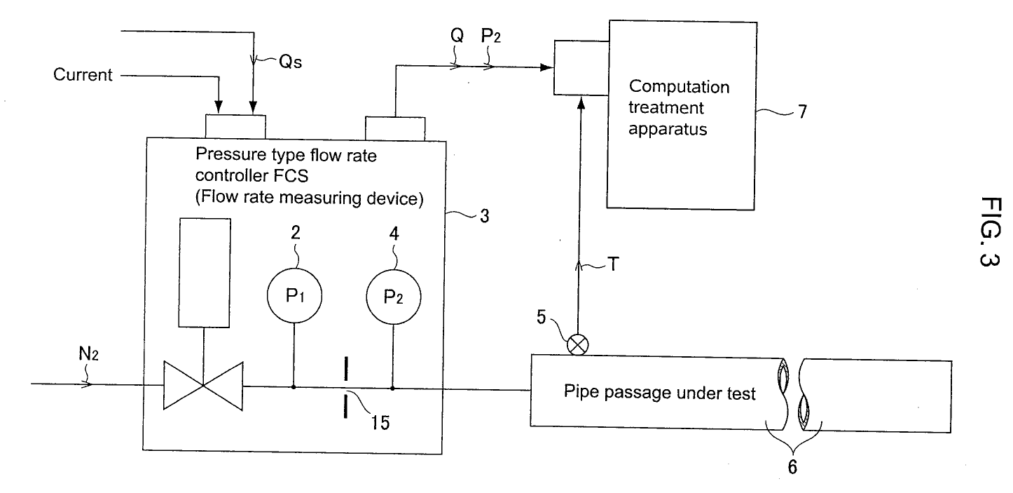

FIG. 3 is a schematic diagram with respect to a second embodiment of the method for testing leakage, in accordance with the present invention, wherein a pressure type flow rate control system FCS, which has been disclosed, is employed as the flow measuring device 3. The pressure type flow rate control system FCS is employed to control the flow rate of gas passing through an orifice 15 by means of controlling the pressure Pi on the upstream side of the orifice 15. The flow rate of N₂ supplied to the pipe passage 6 undergoing testing is automatically maintained at a set value by means of a flow rate setting signal that is inputted as a control signal Q_{S} to the pressure type flow rate control system FCS, and also the flow rate detecting signal Q, the pressure detecting signal P₂, and the like, are obtained as output to devices outside of the detectors.

By adjusting the supply pressure of N₂ from the supply source 8 of the gas used in testing to 3˜10 MPa, flow rate control can be achieved with extremely high accuracy by using the pressure type flow rate control system FCS even when the downstream side pressure P₂ of the orifice 15 goes up to around 0.1˜0.2 Mpa. The result is that highly accurate computation of the internal capacity V_{L} and of the leaked volume of a pipe passage undergoing testing is achieved.

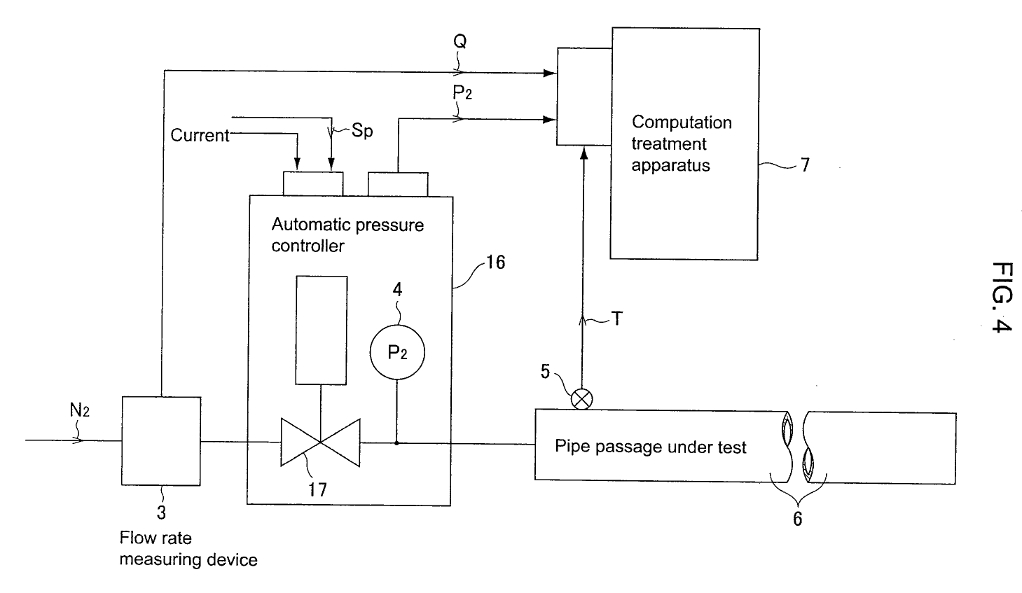

FIG. 4 illustrates an embodiment with respect to the present invention in accordance with the fifth embodiment. It is constituted so that an automatic pressure controller 16 is employed, which allows that the interior of the pipe passage 6 undergoing testing to be maintained at the prescribed pressure value (i.e., 0.4˜0.5 MPa) with high accuracy. The automatic pressure controller 16 is employed as the aforementioned pressure type flow rate control apparatus in FIG. 3, from which orifice 15 is removed. When the set pressure is inputted as a control signal Sp, a control valve 17 is automatically opened or closed for adjustment purposes so as to make the internal pressure P₂ of the secondary side pipe passage to be a set value so that the internal pressure P₂ on the secondary side is maintained at a given value all times.

Referring now to FIG. 4, first the flow measuring device 3 is switched from an “automatic mode” (i.e., a mode in which the supply flow rate Q is automatically adjusted to a given value) to a “usual flow rate measuring mode” when the process for computing the internal quantity V_{L} of the pipe passage 6 undergoing testing has been completed and while the prescribed flow rate of N₂, the gas used in testing, is supplied from the flow rate measuring device 3. Also, an automatic pressure controller 16 is switched from a “usual pressure detecting mode” to an “automatic pressure adjusting mode” (i.e., a mode in which the output side pressure P₂ is maintained at a given set value). As a result, the N₂ flow rate shows the leaked volume from the test passage 6 undergoing testing under a given N₂ supply pressure (e.g., 0.4 MPa) by means of the N₂ flow rate being detected by the flow rate measuring device 3 under the condition wherein the supply pressure of the N₂ gas (i.e. 0.4 MPa) supplied into the pipe passage 6 undergoing testing is maintained at the given value, and the temperature-corrected flow rate detecting value Q directly shows the leaked volume from the pipe passage undergoing testing by simplifying the construction of the leaked volume computation part 10 of the computation treatment apparatus 7 so that only temperature correction of the flow rate detecting signal Q is performed by the temperature correction part 11.

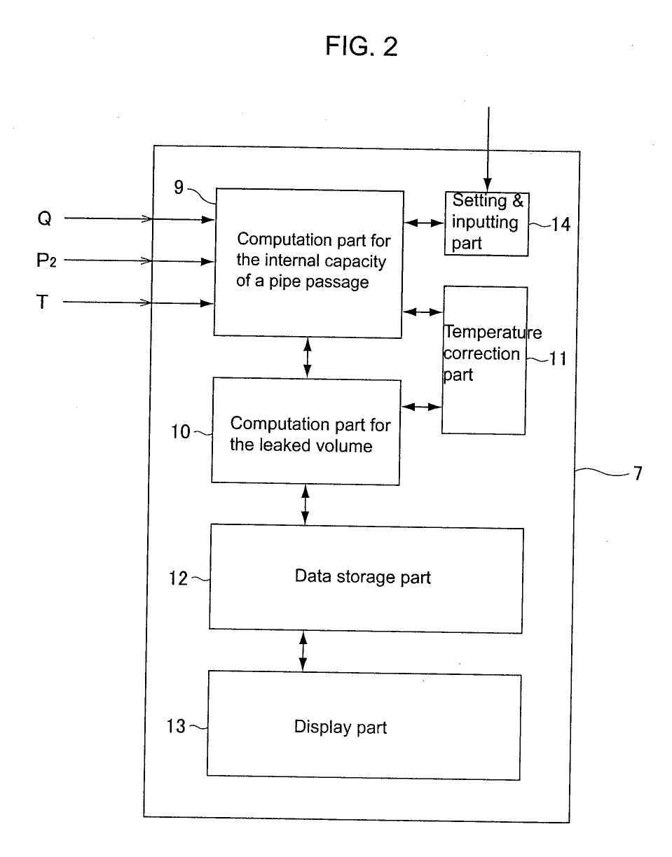

With the aforementioned embodiments shown in FIG. 1, FIG. 2 and FIG. 4, a problem, peculiar to the case wherein the pipe passage 6 undergoing testing is made up of a resin-made piping material, has been neglected. That is, no consideration has been made with respect to the fact that the pressure drop might occur when N₂ gas, used for pressurization, permeates through the pipe wall of the pipe passage 6. However, it goes without saying that it is necessary for the effect of pressure drop, caused by the aforementioned permeation of gas through the pipe wall, to be turned into data beforehand and the data be stored in the data storage part 12 if resin-made piping material is used to make the pipe passage 6 undergoing testing.

### EMBODIMENT 1

FIG. 5 is a schematic diagram illustrating an embodiment of the method for testing leakage in accordance with the present invention. In FIG. 5, 1 designates a pressure adjustor, 2 and 18 designate pressure detectors (pressure transducers), 3 designates a flow rate measuring device, in this case a thermal type mass flow meter (a mass flow controller flow rate·N₂ 100 sccm), 5 designates a temperature detector (a thermostat), 6 designates a pipe passage undergoing testing, 7 designates a computation treatment apparatus (a data logger), 8 designates a N₂ gas source, V₁ and V₂ designate metal diaphragm valves, 19 designates a leak sample (approx. 10⁻⁶˜10⁻⁵ Pa·m³), 20 designates a blind, 21 designates a stainless steel pipe of outer diameter 6.35 mm and inner diameter 4.35 mm, and 22 designates a stainless steel pipe of outer diameter 9.52 mm and inner diameter 7.52 mm.

First, in step (a), a flow rate setting is made for the flow rate measuring device (MFC) 3 in order that the supply flow rate of N₂ gas supplied to the pipe passage 6 undergoing testing is set to 100 sccm (i.e., a flow rate in cc per minute in terms of a standard state of 0° C. and 1 atm). Next, in step (b), valves V₁, V₂ are made fully opened in order to allow the N₂ gas to flow, and the flow rate of the flow rate measuring device 3 is stabilized, and in step (c) the computation treatment apparatus 7 (a data logger) is readied for a start-up of the operation.

Furthermore, in step (d), the valve V₂ is fully closed after a lapse of 60 seconds subsequent to start-up of the aforementioned computation treatment apparatus 7, and the pressure P₂, P₃, the N₂ flow rate Q, and the temperature T, are detected every 5 sec, and each value detected is inputted into the computation treatment apparatus 7.

Using the computation treatment apparatus 7, the internal capacity V_{L} of the pipe passage 6 undergoing testing is first computed by using the detected values obtained through the aforementioned operations (a) to (d). More specifically, (i) the pressure detecting value P₂ is converted to correspond to the temperature value of 0° C. by using the following equation:

P₂₀=[(P₂+0.101325)×273/(T+273)]−0.101325 (MPa),

wherein P₂ is a pressure detecting value, T is a temperature detecting value (° C.), and P₂₀ is a computation value (MPa) corresponding to 0° C.

Next, (ii) a pressure rise rate (MPa/sec) is computed by plotting the relationship between the computation value P₂₀ of the detection value P₂ and time. Then, (iii) the internal capacity V_{L} (cc) of the pipe passage 6 under a standard condition is computed using the flow rate Q=100 sccm of the flow rate measuring apparatus 3, and the aforementioned pressure rise rate, by using the following equation:

V_{L}(CC)=[0.101325 (MPa)×Q (sccm)]/[pressure rise rate (MPa/sec)×60 (sec)].

It goes without saying that the aforementioned detection values, and computation values, are stored in succession into the data storage part 12 of the computation treatment apparatus 7.

Following completion of the measurements required in order to compute the aforementioned internal capacity V_{L} of the pipe passage, the N₂ gas is supplied until the inside of the pipe passage 6 is pressurized to the set pressure (e.g., 0.45 MPa), and the valve V₁ is closed. Then, pressure changes are measured over a given period of time, and, upon completion of measuring pressure changes, the valve V₂ is opened and the flow rate measuring device 3 is forcefully released so that the pressure inside the pipe passage undergoing testing is released. In accordance with the present embodiment, the method and apparatus for testing leakage are made so that the aforementioned pressure changes are measured every 5 sec over 5 hours. However, it goes without saying that the measuring intervals and the testing time can be appropriately altered depending on the size of the internal capacity, and the leaked volume, of the pipe passage 6 undergoing testing.

Using the aforementioned computation treatment apparatus 7, the leaked volume Q_{L} from the pipe passage 6 is computed by using the detected values of the aforementioned pressure changes. More specifically, first, (a) the pressure detection value P₂ (MPa) is converted to the pressure value P₂₀ (MPa) at 0° C. (The equation to be used for the conversion is the same as the one in paragraph [0045] above). Next, (b) the pressure drop rate (MPa/sec) is obtained by plotting the relationship between the aforementioned converted pressure detection value P₂₀ (MPa) and time. Furthermore, (c) by using the following equation the leaked volume, Q_{L}(Pa·m³/sec), is computed using the aforementioned pressure drop rate and the internal capacity V_{L} (CC) of the pipe passage 6 previously obtained by calculation:

Leaked volume=pressure drop rate (MPa/sec)×10⁶×internal capacity of a pipe passage V_{L} (cc)×10⁻⁶.

In accordance with the explanations made above, all of the computations are conducted by using the detection pressure P₂ obtained by the pressure detector 2. However, in accordance with the present embodiment, computation is also made at the same time as detection by using the detection pressure P₃ obtained by the pressure detector 18 installed before the leak sample 19.

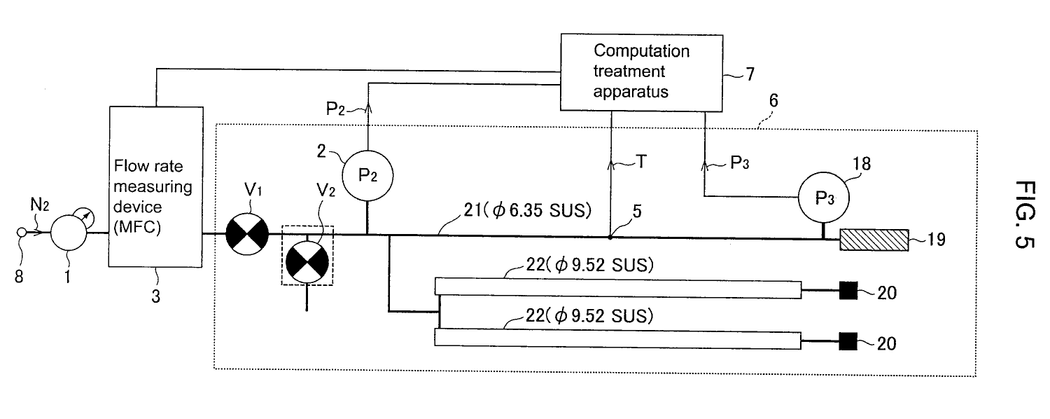

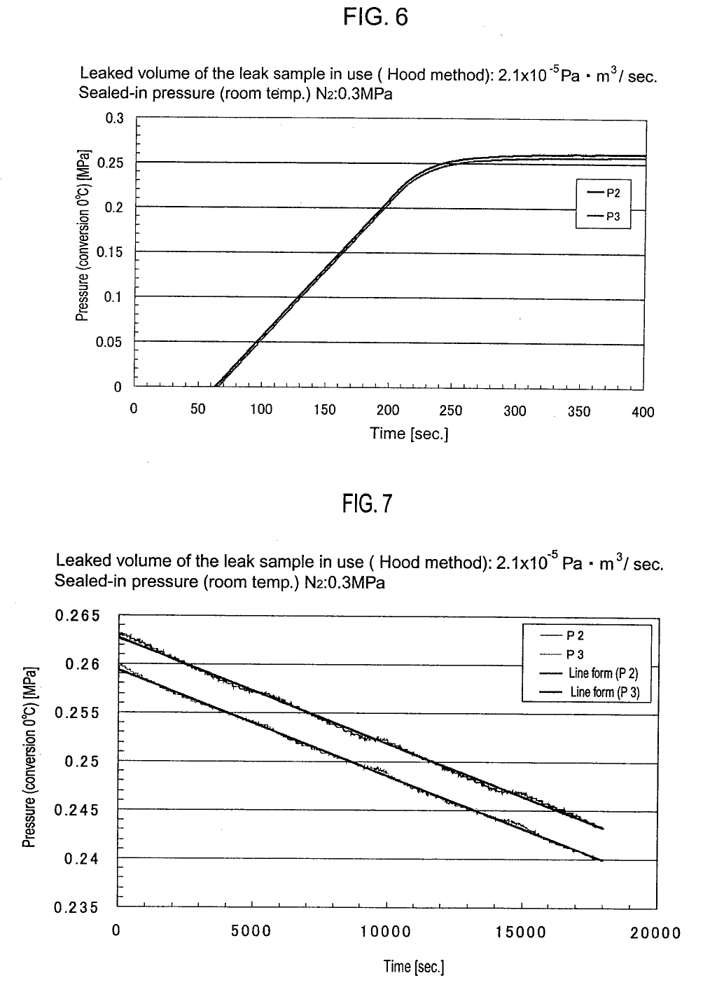

Table 1 shows the computation values of the internal capacity V_{L} of a pipe passage 6 undergoing testing at the time when the leak sample 19 in use is approximately 2.1×10⁻⁵ pa·m³/sec and, also, the sealed-in pressure (the pressure applied) of the N² gas is made to be 0.3 MPa, where P₂ corresponds to the computation value when the detection value detected by the pressure detector 2 is used, and P₃ corresponds to the computation value when the detection value detected by the pressure detector 18 is used. What the relationship is between the internal pressure of the pipe passage and time is plotted (i.e., pressure rise rate) at the time when pressure is applied as shown in FIG. 6.

TABLE 1
Computation results of the internal capacity of a pipe passage

| | | | |
|---|---|---|---|
| | | | Computed |
| Pressure | Pressure rise | | internal |
| range | rate | Flow rate | capacity |
| [MPa] | [MPa/sec.] | [sccm] | [cc] |

P₂

| | | | |
|---|---|---|---|
| 0.05~0.10 | 1.54E−03 | 100.0 | 109.9 |
| 0.15~0.20 | 1.53E−03 | 100.0 | 110.4 |
| 0.10~0.20 | 1.53E−03 | 100.0 | 110.4 |

P₃

| | | | |
|---|---|---|---|
| 0.05~0.10 | 1.54E−03 | 100.0 | 110.0 |
| 0.15~0.20 | 1.53E−03 | 99.9 | 110.3 |
| 0.10~0.20 | 1.53E−03 | 100.0 | 110.4 |

Table 2 shows the results of computing the leaked volume Q_{L} (Pa·m/sec) by using the internal capacity V_{L} shown in Table 1. What the relationship is between the internal pressure of the pipe passage and time is plotted, at the time of sealing in the pressure, as shown in FIG. 7.

TABLE 2
Computation results of the leaked volume QL

| | | |
|---|---|---|
| Range of | Pressure drop | Leaked volume |
| computation | rate [MPa/sec.] | [Pa · m³/sec.] |

P₂

| | | |
|---|---|---|
| 2 hr. | −1.13E−06 | 1.25E−04 |

P₃

| | | |
|---|---|---|
| 2 hr. | −1.12E−06 | 1.23E−04 |

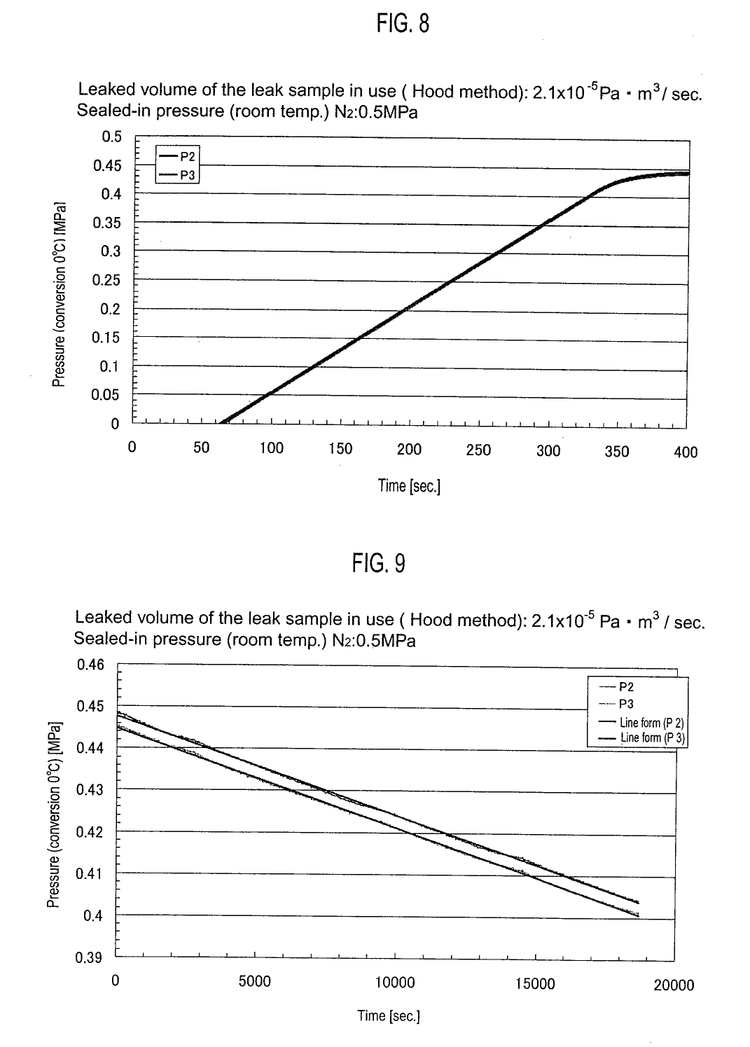

Table 3 shows the computation values of the internal capacity V_{L} of a pipe passage 6 undergoing testing at the time when the same leak sample 19 is used, and the sealed-in pressure (pressure applied) of N₂ gas is raised to 0.5 MPa. Table 4 shows the computation value of the leaked value (Pa·m³/sec) of the pipe passage 6 in the case when the internal capacity V_{L} of the pipe passage, as shown in Table 3, is being used. As apparent from the comparison of the above Table 1 and Table 3, the computation results for the internal capacity of the pipe passage show nearly fixed values even when the pressure ranges are different, thus making it possible to compute the internal capacity for any pressure range. FIG. 8 shows what the relationship is between the internal pressure of the pipe passage and time as plotted (i.e., pressure rise rate) at the time when pressure is supplied in the same manner as in the embodiment of FIG. 6. FIG. 9 shows what the relationship is between the internal pressure of the pipe passage and time as plotted (pressure drop rate) at the time when pressure is sealed in the same manner as in the embodiment of FIG. 7.

TABLE 3

| | | | |
|---|---|---|---|
| | | | Computed |
| Pressure | Pressure rise | | internal |
| range | rate | Flow rate | capacity |
| [MPa] | [MPa/sec.] | [sccm] | [cc] |

P₂

| | | | |
|---|---|---|---|
| 0.05~0.10 | 1.53E−03 | 100.0 | 110.3 |
| 0.35~0.40 | 1.52E−03 | 100.0 | 111.1 |
| 0.10~0.40 | 1.52E−03 | 100.0 | 110.8 |

P₃

| | | | |
|---|---|---|---|
| 0.05~0.10 | 1.53E−03 | 100.0 | 110.3 |
| 0.35~0.40 | 1.52E−03 | 99.9 | 111.2 |
| 0.10~0.40 | 1.52E−03 | 100.0 | 110.8 |

TABLE 4
Computation results of the leaked volume QL

| | | |
|---|---|---|
| Range of | Pressure drop | Leaked volume |
| computation | rate [MPa/sec.] | [Pa · m³/sec.] |

P₂

| | | |
|---|---|---|
| 2 hr. | −2.50E−06 | 2.75E−04 |

P₃

| | | |
|---|---|---|
| 2 hr. | −2.51E−06 | 2.76E−04 |

Lastly, the leak sample 19, used for the leakage test in FIG. 5, is immersed in isopropyl alcohol (IPA) and N₂ gas is supplied to the leak sample 19 so as to collect air bubbles leaked out of the leak sample 19. In this way, the actual volume leaked out of the leak sample 19 is measured. Table 5 is used to compare the results of the IPA immersion test and the computation value of the leaked volume Q_{L}.

TABLE 5
Comparison of the IPA immersion test result and the computation
value of the leaked volume
Leak sample in use 2.1 × 10 ⁻⁵ Pa · m³/sec (Hood method)

| | | Computation value of |
|---|---|---|
| N2 supply | IPA immersion test | the leaked volume (5 hr) |
| pressure | [Pa · m³/sec.] | [Pa · m³/sec.] |
| 0.3 MPa | 1.1E−04 | 1.25E−04 |
| 0.5 MPa | 2.5E−04 | 2.75E−04 |

As apparent from the above Table 5, it is possible to compute the internal capacity V_{L} of the pipe passage 6 undergoing testing with high accuracy, and it is also shown that the computed internal capacity V_{L} has sufficient reproducibility. The leaked volume Q_{L} of the pipe passage 6 computed in accordance with the present invention almost accords exactly with the result of measurements by the Isopropyl Alcohol (IPA) immersion test.

When it is found that the leaked volume is higher than an allowable volume upon completion of the test, the exact spot where leakage occurred must be found by employing another test. Ordinarily, the place where leakage occurs can be spotted by using a helium leak detector so that He gas leaking from the spot where the leak occurred can be detected. To do so, He gas, instead of N₂ gas, is used to supply gas into the pipe passage 6 undergoing testing, and the internal capacity V_{L} and leaked volume Q_{L} are computed using the internal pressure of the He gas. Also, the spot of leakage of the He gas can be detected by using a helium leak detector and also by means of a “sniffing method,” which is one of various test methods used to detect He leakage.

### Feasibility of Industrial Use

The present invention is applicable to leakage tests of pipe passages that are used not only in semiconductor manufacturing facilities, and chemical products manufacturing facilities, but also in the food products processing industry, the city gas supply industry, and many other industries.

1. A method for testing leakage of a pipe passage comprising the steps of:
(a) supplying a certain flow rate of gas used in testing to an inside of a pipe passage undergoing testing and that is hermetically closed on one side while detecting the flow rate with a flow measuring device and detecting pressure of the gas with a pressure detector;
(b) detecting temperature of the gas used in testing and supplied to the pipe passage;
(c) inputting the detected values of pressure, flow rate and temperature into a computation treatment apparatus; and
(d) computing an internal capacity V_{L} of the pipe passage undergoing testing as
VL=(supplied flow rate Q×pressure applied time Δt)/(pressure rise value ΔP2).
using the pressure applied time Δt required for the pressure rise value ΔP₂ of the pipe passage to reach a set value and the supplied flow rate Q of the gas used in testing, and next, computing volume QL leaked from the pipe passage undergoing testing as
QL=(pressure drop value ΔP₂×internal capacity V_{L} of the pipe passage)/(pressure drop time Δt′),
using the pressure drop value ΔP2′ after a lapse of the given pressure drop time Δt′ subsequent to application of pressure to the inside of the pipe passage undergoing testing to the given set pressure and the computed internal capacity V_{L} of the pipe passage.

2. A method for testing leakage of a pipe passage claimed in claim 1, wherein the detected pressure value corresponding with pressure detecting signal P2 is corrected using temperature detecting signal T, and the internal capacity V_{L} and leaked volume QL of the pipe passage undergoing testing are computed using the detected pressure value corrected to a first value at a predetermined standard temperature.

3. A method for testing leakage of a pipe passage as claimed in claim 1, wherein internal pressure of the pipe passage used in computation of the internal capacity V_{L} is raised from 0.1 MPa to 0.2 MPa, and a maximum pressurization value is made to be 0.4 MPa, and the pressure drop time Δt′ is made to be 1 hour for the computation of the leaked volume QL.

4. A method for testing leakage of a pipe passage as claimed in claim 1, wherein a pressure type flow controller is used as the flow measuring device and as the pressure detecting device, and a flow rate detecting signal and a pressure detecting signal of said pressure type flow controller are utilized as signals corresponding to supplied flow rate Q and detected pressure P2, respectively.

5. A method for testing leakage of a pipe passage comprising the steps of:
(a) supplying a certain flow rate of gas used in testing is to an inside of a pipe passage undergoing testing and that is hermetically closed on one side while detecting the flow rate with a flow measuring device and detecting pressure with a pressure detector;
(b) detecting temperature of the gas used in testing and supplied to the pipe passage
(c) inputting the detected values of pressure, flow rate and temperature into a computation treatment apparatus; and
(d) computing an internal capacity V_{L} of the pipe passage undergoing testing as
VL=(supplied flow rate Q×pressure applied time Δt)/(pressure rise value ΔP2),
using the pressure applied time Δt required for the pressure rise value ΔP2 of the pipe passage to reach a set value and the supplied flow rate Q of the gas used in testing, and next, supplying the gas used in testing in a state wherein pressure P2 in the pipe passage is maintained at a given value by an automatic pressure controller so that a leaked volume QL leaked from the pipe passage undergoing testing is obtainable by using the flow rate Q detected by the flow measuring device.

6. A method for testing leakage of a pipe passage as claimed in claim 5, further comprising a step wherein supply of the gas used in testing is temporarily halted during a time when pressure is rising in the pipe passage, and pressure changes occurring inside the pipe passage undergoing testing are confirmed.

7. An apparatus for testing leakage of a pipe passage, the apparatus comprising a computation treatment apparatus, wherein the computation treatment apparatus comprises:
(a) a supply source of a gas used in testing, wherein the gas is supplied to a pipe passage that undergoes a test;
(b) a flow measuring device disposed to detect a given flow rate of the gas used in testing when the gas flows from the supply source into a hermetically closed pipe passage undergoing testing;
(c) a pressure detecting device for disposed to detect pressure in the pipe passage;
(d) a temperature detecting device disposed to detect temperature of the pipe passage or temperature of the gas used in testing;
(e) a first computation part for computing internal capacity V_{L} of the pipe passage when the flow measuring device inputs a supplied flow rate Q detecting signal, the pressure detecting device inputs a pressure detecting signal P2, and the temperature detecting device inputs a temperature detecting signal T to the first computation part so that the first computation part computes the internal capacity V_{L} of the pipe passage as
VL=(supplied flow rate Q)×(pressure applied time Δt)/(pressure rise time ΔP2).
using the pressure applied time Δt required for the pressure rise value ΔP2 of the pipe passage undergoing testing to reach a set value and the supplied flow rate Q of the gas used in testing; and
(f) a second computation part for computing a leaked volume QL, wherein the second computation part computes the leaked volume QL as
QL=(pressure drop value ΔP2′)×internal capacity V_{L} of the pipe passage)/pressure drop time Δt′),
using the pressure drop value ΔP2′ after a lapse of the prescribed pressure drop time Δt′ of internal pressure of the pipe passage undergoing testing and pressurized to a prescribed pressure and using the computed internal capacity V_{L} of the pipe passage undergoing testing.

8. An apparatus for testing leakage of a pipe passage as claimed in claim 7, wherein the computation treatment apparatus further comprises:
(g) a temperature correction part for correcting the pressure detecting signal P2; and
(h) a data storage part for storing the detected flow rate Q, pressure detecting signal P2, and a temperature detecting signal T.

9. An apparatus for testing leakage of a pipe passage as claimed in claim 7, wherein a pressure type flow measuring device is utilized as the flow measuring device and as the pressure detector.

10. A method for testing leakage of a pipe passage as claimed in claim 2, wherein internal pressure of the pipe passage used in computation of the internal capacity V_{L} is raised from 0.1 MPa to 0.2 MPa, and a maximum pressurization value is made to be 0.4 MPa, and the pressure drop time Δt′ is made to be 1 hour for computation of the leaked volume QL.

11. A method for testing leakage of a pipe passage as claimed in claim 2, wherein a pressure type flow controller is used as the flow measuring device and as the pressure detecting device, and a flow rate detecting signal and a pressure detecting signal of said pressure type flow controller are utilized as signals corresponding to supplied flow rate Q and detected pressure P2, respectively.

12. An apparatus for testing leakage of a pipe passage as claimed in claim 8, wherein a pressure type flow measuring device is utilized as the flow measuring device and as the pressure detector.
